(19) United States
(12) Patent Application Publication
(10) Pub. No.: US 2009/0140519 A1
(43) Pub. Date: Jun. 4, 2009

(54) Quick connect tubular coupling

(75) Inventors: Sandeep Jayant Pavnaskar, Peoria, IL (US); Brandon Jeffery Croegaert, Mapleton, IL (US); Robert Earl Long, Tremont, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/987,525

(22) Filed: Nov. 30, 2007

(51) Int. Cl. F16L 37/00

(52) U.S. Cl. 285/308

(57) ABSTRACT

A male connector is disclosed. The male connector may have a tubular shank, and a release sleeve connected to the tubular shank. The male connector may also have an unlocking insert movable with the release sleeve. The male connector may additionally have a release nut threadably attached to the tubular shank and configured to contact the release sleeve and move the unlocking insert.

### TECHNICAL FIELD

The present disclosure relates generally to a quick connect tubular coupling and, more particularly, to a quick connect tubular coupling having a release nut.

### BACKGROUND

Quick connect tubular couplings are used in numerous industries including agricultural, construction, forestry, transportation, and utility. For example, quick connect tubular couplings are commonly used to connect refrigerant supply lines, power steering lines, pneumatic brakes lines, air supply lines, transmission oil lines, heat exchangers, fuel lines, hydraulic tool circuits, and pilot control lines. Quick connect tubular couplings increase the speed and ease of connecting two tubular elements to each other, but are limited in diameter to the size of the tubular members and in the maximum allowable pressure of the connection. As the diameter and/or fluid pressure increase in a quick connect tubular coupling, the difficulty of disconnecting the coupling may also increase. That is, as pressure builds in the coupling, the pressure itself may serve to tighten the connection to a point that operators may be unable to disconnect the coupling. Similarly, as the diameter increases for a given pressure, the resulting disconnect force proportionally increases.

One example of a quick connect coupling has been described in U.S. Pat. No. 6,688,655 (the '655 patent) to Watanabe. The '655 patent discloses a quick connection-release coupling to connect a male coupling part and a female coupling part. The female coupling part includes a C-shaped spring ring housed in an annular groove for locking engagement with an engagement portion of the male coupling part. A release jig is threadably attached to the male coupling part and includes a threaded portion, a dust cover, and a front end portion. Disengagement of the C-shaped spring ring from the engagement portion of the male coupling part is achieved by rotating the release jig on the male coupling member toward the C-shaped spring ring until the front end portion of the release jig strikes and moves the C-shaped spring ring away from the male coupling part to disengage the male and female coupling parts.

Although the release jig of the '655 patent may reduce the difficulty of disconnecting coupled parts, it may have limited applicability and be expensive to manufacture and repair. The '655 may have limited applicability because the release jig is intended to be manually operated by an operator without the use of torque enhancing tools. Hence, the coupling of the '655 patent may not be adequate for use in high pressure systems, because the male and female coupling parts of the '655 patent may be incapable of being disconnected under high pressures without the aid of a torque enhancing tool. Further, the '655 patent integrates the threaded portion, the dust cover, and the front end portion into a single release jig, and integration of the three elements may increase manufacturing costs by requiring a single complex part to be manufactured. Further, if any of the separate parts of the release jig fail, the entire release jig would need to be replaced at a higher expense than the replacement cost of only a single damaged element.

The disclosed quick connect tubular coupling is directed to overcoming one or more of the problems set forth above.

### SUMMARY

In one aspect, the present disclosure is directed to a male connector. The male connector may include a tubular shank. The male connector may further include a release sleeve connected to the tubular shank, and an unlocking insert movable with the release sleeve. The male connector may additionally include a release nut threadably attached to the tubular shank and configured to contact the release sleeve and move the unlocking insert.

In another aspect, the present disclosure is directed to a female connector. The female connector may include a tubular member. The female connector may further include a bore located within the tubular member and having a central axis. The female connector may also include an annular groove located within the bore. The female connector may additionally include a flexible latch ring disposed within the annular groove. The female connector may yet further include at least one spring-loaded ball positioned in the bore and biased toward the central axis.

### BRIEF DESCRIPTION OF THE DRAWINGS

FIG. 1 is a partial section, side-view illustration of an exemplary quick connect tubular coupling shown in a disconnected position;

FIG. 2-4 are partial section, side-view illustrations of the exemplary quick connect tubular coupling of FIG. 1 transitioning from a disconnected position in FIG. 2 to a connected position in FIG. 4;

FIG. 5 is a partial section, side-view illustration of a quick connect tubular cap including an exemplary grip handle;

FIG. 6 is a partial section, side-view illustration of a quick connect tubular plug including an exemplary grip handle;

FIG. 7 is a partial section, side-view illustration of a quick connect tubular coupling including an exemplary threaded female adaptor in a disconnected position; and

FIG. 8 is a partial section, side-view illustration of a quick connect tubular coupling including an exemplary threaded female adaptor in a connected position.

FIG. 9 is a partial section, side-view illustration of the exemplary quick connect tubular coupling of FIG. 1 returning back to the disconnected position;

### DETAILED DESCRIPTION

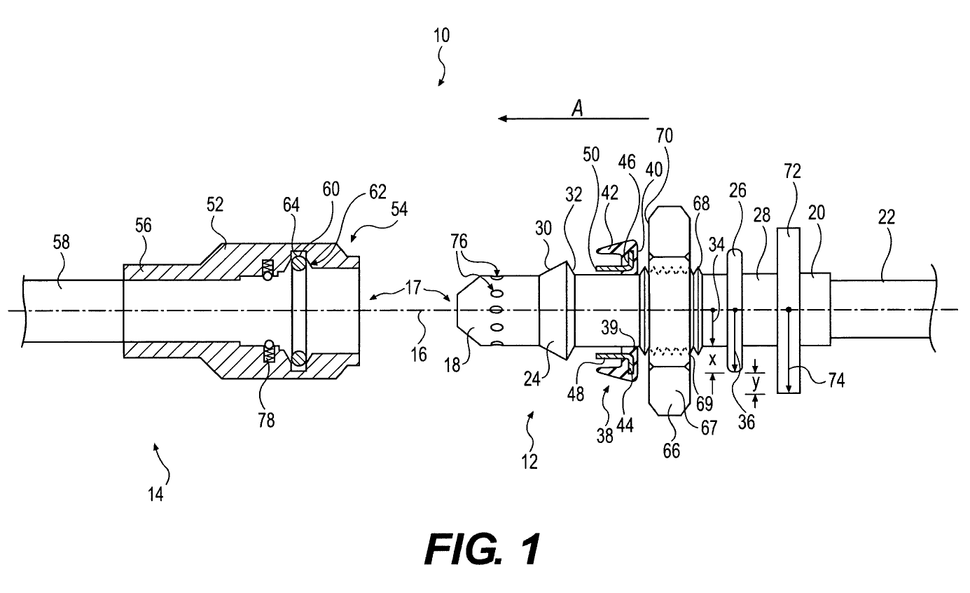

Referring to FIG. 1, a quick connect tubular coupling 10 may include a male connector 12 and a female connector 14. During the process of connection, male connector 12 and female connector 14 may be oriented coaxially along a common longitudinal axis 16. Male connector 12 and female connector 14 may include longitudinally extending bores 17 (not shown in male connector 12) for allowing passage of fluid.

Male connector 12 may include a first end 18 for insertion into female connector 14 and a second end 20 attachable to a conduit 22. Male connector 12 may further include a shoulder 24 and a cylindrical stop 26 located circumferentially around a tubular shank 28. Shoulder 24 may be generally frusto-conical in shape, and cylindrical stop 26 may be generally cylindrical in shape. Shoulder 24 and cylindrical stop 26 may be axially spaced from each other and integrally formed or otherwise attached to tubular shank 28. Shoulder 24 may be located proximate first end 18, and include a forward angled surface 30 facing toward first end 18. Shoulder 24 may further include a rearward angled surface 32 facing toward second end 20. Forward angled surface 30 may be steeper than rearward angled surface 32. For example, forward angled surface 30 may have an interior angle in the range of about 5 to 25 degrees relative to longitudinal axis 16, and rearward angled surface 32 may have an interior angle in the range of about 30-60 degrees relative to longitudinal axis 16. More specifically, forward angle surface 30 may be within a range of about 5-8 degrees and rearward angle surface may be within a range of about 46-60 degrees. For applications of large diameter connections and/or large maximum allowable fluid pressure, quick connect tubular coupling 10 may include a decreased angle of forward angled surface 30 to increase ease of connection, and may include an increased angle of rearward angled surface 32 to decrease the likelihood of a premature disconnection. For a relatively small diameter (e.g., ½ inch) and a low maximum allowable pressure (e.g., 4,250 psi), quick connect tubular coupling 10 may include forward angled surface 30 with an interior angle relative to longitudinal axis 16 of about 18 degrees, and rearward angled surface 32 with an interior angle relative to longitudinal axis 16 of about 45 degrees. However, for example, a quick connect tubular coupling 10 with a larger diameter (e.g., 1½ inch) and higher maximum allowable pressure (e.g., 6,000 psi) may include forward angled surface 30 with an interior angle relative to longitudinal axis 16 of about 7 degrees, and may include rearward angled surface 32 with an interior angle relative to longitudinal axis 16 of about 55 degrees.

Cylindrical stop 26 may be located between shoulder 24 and second end 20. Cylindrical stop 26 may have a cylindrical stop radius 36 defined as a distance between longitudinal axis 16 and a maximum exterior radius of cylindrical stop 26. Tubular shank 28 may have a shank radius 34 defined as a distance between longitudinal axis 16 and an exterior surface of an unthreaded portion of tubular shank 28. The difference between shank radius 34 and cylindrical stop radius 36 may defined by a distance X.

Additionally, male connector 12 may include a release sleeve 38, which may be located between shoulder 24 and cylindrical stop 26. Release sleeve 38 may be formed from an elastic material, thereby capable of rebounding after deformation. Release sleeve 38 may be generally cylindrical in shape and include a radial portion 39 fixedly attached to a circumference of tubular shank 28 and extending radially outward from tubular shank 28. Radial portion 39 may include a radial surface 40 facing toward second end 20. Release sleeve 38 may further include a protective cover 42 extending in a direction substantially along longitudinal axis 16. Protective cover 42 may help protect quick connect tubular coupling 10 from invasion of foreign objects that may potentially interfere with the connection of male connector 12 and female connector 14. An unlocking insert 44 may be movable with release sleeve 38.

Unlocking insert 44 may be generally cylindrical and include a generally L-shaped cross section defining a radially extending portion 46 and an axially extending portion 48. Radially extending portion 46 may be at least partially embedded in radial portion 39 of release sleeve 38. Further, axially extending portion 48 may protrude from radial portion 39 of release sleeve 38 toward first end 18 of male connector 12. A distal end 50 of axially extending portion 48 may be squared (as shown in FIG. 1) or, alternatively, may be tapered (not shown) or rounded (not shown). Since unlocking insert 44 may be partially embedded in release sleeve 38 and not directly attached to any other element when quick connect tubular coupling 10 is disconnected, unlocking insert 44 may be free to move with release sleeve 38. Unlocking insert 44 may be made of a rigid material such as metal.

Male connector 12 may include a release nut 66 engaged with a threaded portion 68 of tubular shank 28, and located between release sleeve 38 and cylindrical stop 26. Cylindrical stop 26 may serve to limit movement of release nut 66 in a direction toward second end 20. Release nut 66 may be a polygonal shaped nut. For example, release nut 66 may be a hexagonal nut including a hexagonal outer surface 67 and a threaded inner surface 69 in movable contact with threaded portion 68 of tubular shank 28. Release nut 66 may be movable in a direction along longitudinal axis 16 to forcibly engage radial surface 40 of release sleeve 38. Release nut 66 may be operatively moved by rotation thereof with a tool (not shown). The tool may be any known tool for imparting rotation on release nut 66 and increasing the amount of torque an operator may apply to release nut 66. For example, the tool may be a wrench.

Male connector 12 may also include a gripping lip 72 circumferentially attached to tubular shank 28 between cylindrical stop 26 and second end 20. Gripping lip 72 may be generally cylindrical in shape and may have a radius 74 defined as a distance between longitudinal axis 16 and a maximum exterior surface of gripping lip 72. Radius 74 may be larger than cylindrical stop radius 36 by a distance Y. It may be desirable to include gripping lip 72 on male connector 12 to increase a gripping surface for an operator when disconnecting male connector 12 from female connector 14. It is contemplated that in place of a separate gripping lip 72, it may desirable to increase the size (length and/or diameter) of cylindrical stop 26 to achieve a larger gripping surface. Gripping lip 72 may be sized to provide a gripping surface necessary for an operator to disconnect male connector 12 and female connector 14. For example, gripping lip radius 74 may be larger than a radius of release nut 66. Gripping lip 72 may be generally cylindrical in shape or have various other ergonomic shapes (not shown) that may improve an operator's ability to grip male connector 12. In addition or as an alternative to gripping lip 72 being located on male connector 12, it is also contemplated that gripping lip 72 may be located circumferentially around an exterior surface of female connector 14 to aid disconnection of quick connect tubular coupling 10. Gripping lip 72 may be integral with or securely attached to male connector 12 and/or female connector 14 by any known method including, for example, welding or crimping.

Female connector 14 may include a tubular member 52 having a first end 54 for receiving male connector 12, and a second end 56 attachable to a conduit 58. Female connector 14 may also include a locking member positioned within bore 17 for locking female connector 14 and male connector 12. In one embodiment, locking member may be a latch ring 60. Latch ring 60 may be substantially circular in shape and flexible. It is contemplated that latch ring 60 may be expandable to increase its diameter. Female connector 14 may further include a wedge surface 62 and an annular groove 64 for retaining latch ring 60 within bore 17 of female connector 14.

Male connector 12 may include an indent 76 proximate first end 18 that mates with a spring-loaded ball 78 housed within bore 17 of female connector 14, when quick connect tubular coupling 10 is secured by latch ring 60. It is contemplated that a plurality of indents 76 and corresponding spring-loaded balls 78 may be positioned equally and circumferentially around male connector 12 and annually within bore 17 of female connector 14, respectively. Spring loaded balls 78 may be biased toward a central axis of bore 17 corresponding with longitudinal axis 16. With the use of the indents 76 and spring-loaded ball 78, male connector 12 may be inserted into female connector 14 at any rotational position but then rotationally held in place to prevent relative rotation between male connector 12 and female connector 14 once quick connect tubular coupling 10 is secured.

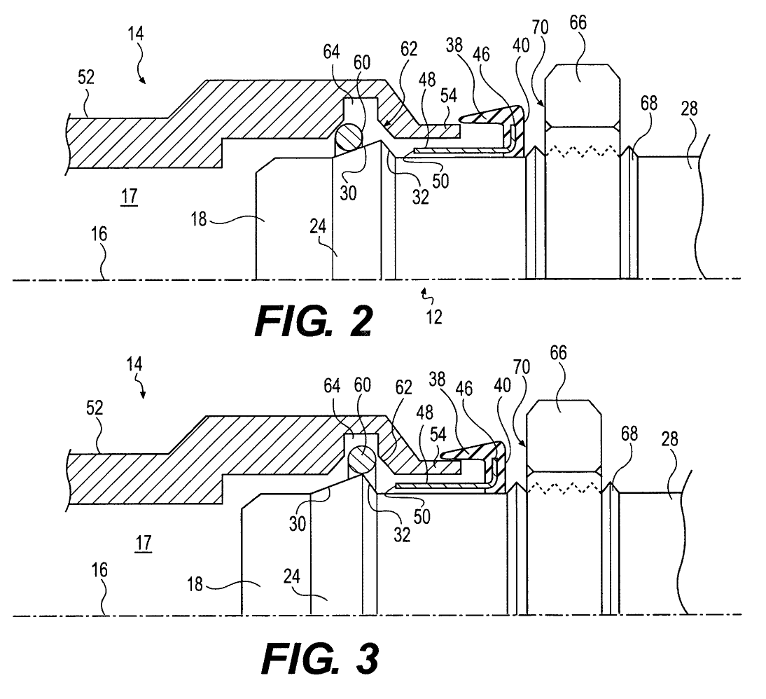

Referring to FIG. 2, to secure quick connect tubular coupling 10, first end 18 of male connector 12 may be inserted into bore 17 of female connector 14. As male connector 12 enters bore 17 of female connector 14, shoulder 24 may contact latch spring 60 via forward angled surface 30 to thereby spread latch ring 60 from a contracted position to an expanded position (see FIG. 3). As latch ring 60 transitions from the contracted position to the expanded position, shoulder 24 may slide past latch ring 60. As shoulder 24 moves past latch ring 60, latch ring 60 may be permitted to return radially inward and move toward first end 54 of female connector 14, from annular groove 64 to a locked position between rearward angled surface 32 of shoulder 24 and wedge surface 62 of female connector 14 (see FIG. 4). Male connector 12 and female connector 14 may then be connected and locked into place. As fluid pressure is applied to quick connect tubular coupling 10, latch ring 60 may become wedged even tighter between rearward angled surface 32 and wedge surface 62. That is, due to the steep angle of rearward angled surface 32, latch ring 60 may be sandwiched between rearward angled surface 32 and wedge surface 62 as the pressure increases in bore 17.

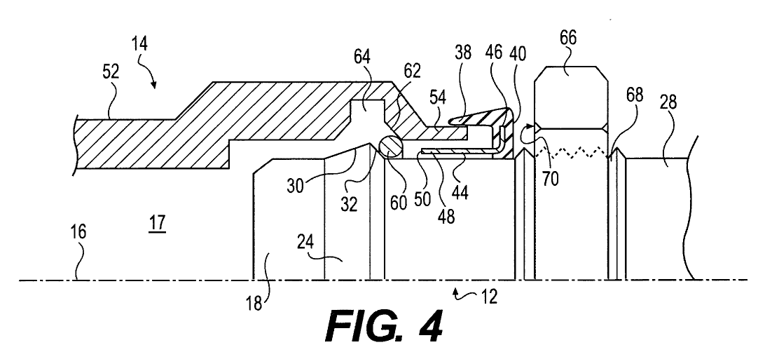

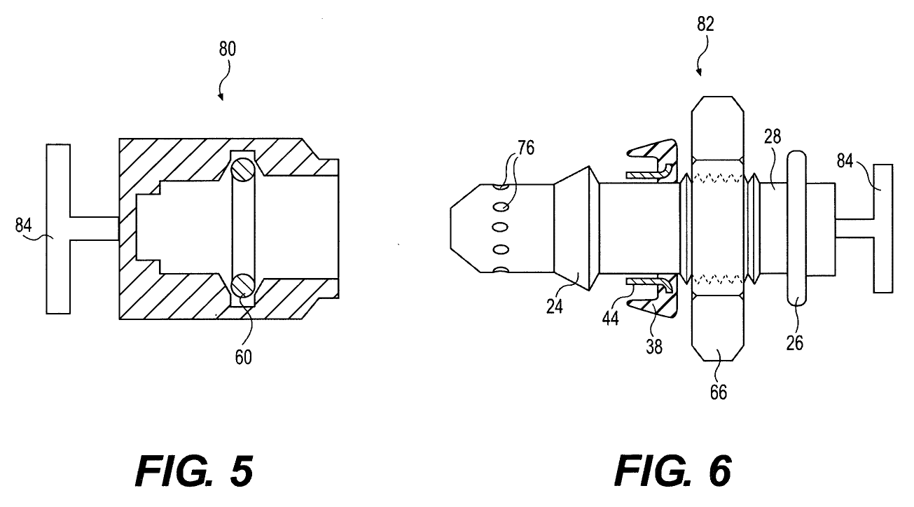

Referring to FIGS. 5 and 6, it may be desirable to implement a female connector cap 80 or a male connecter plug 82 to block fluid passage or contamination when male connector 12 is disconnected from female connector 14. Like female connector 14, female connector cap 80 may include a latch ring 60 for permitting a quick connection with male connector 12. Further, like male connector 12, male connector cap 82 may include a shoulder 24, a cylindrical stop 26, and a tubular shank 28, for permitting a quick connection with female connector 14. In order to increase an operator's ability to connect or disconnect female connector cap 80 and male connector plug 82, a handle 84 may be attached to a distal end 86 of female connector cap 80 and a distal end 88 of male connector plug 82. Handle 84 may be generally T-shaped (as shown in FIGS. 5-6) or, alternatively, may take any other shape to increase an operator's ability to grip female connector cap 80 and male connector plug 82.

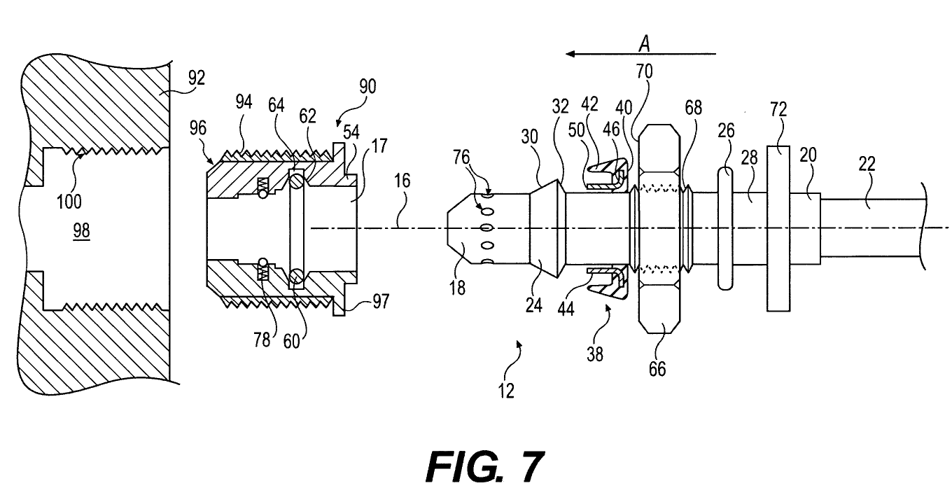

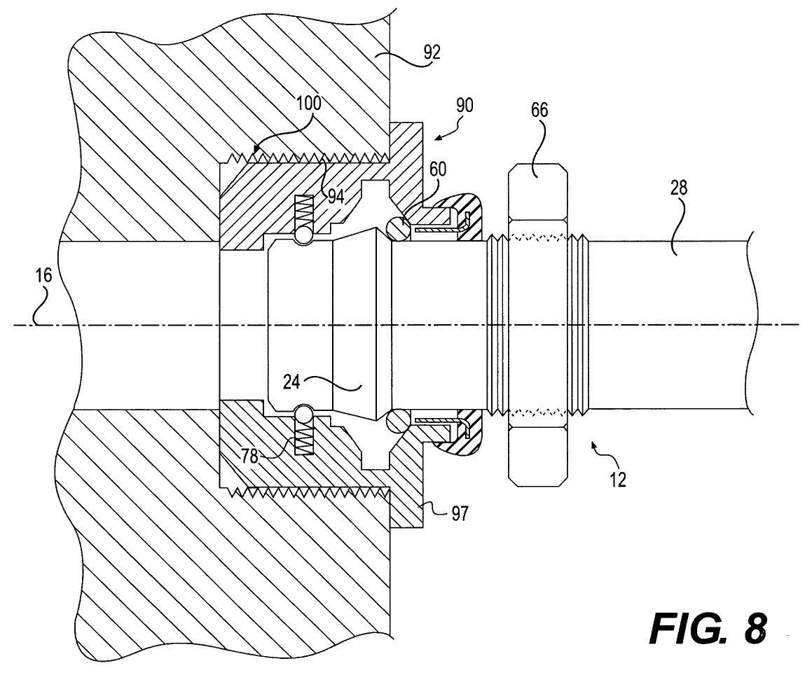

Referring to FIGS. 7 and 8, a female threaded adaptor 90 may be connected inside a hydraulic component 92 and, like female connector 14, may be configured to receive male connector 12. Specifically, female threaded adaptor may include a bore 17, a latch ring 60, a wedge surface 62, and an annular groove 64. Further, female threaded adaptor 90 may include an external threaded portion 94 located on an outer surface 96 of female threaded adaptor 90. It is contemplated that external threaded portion 94 may extend along a majority of outer surface 96. Female threaded adaptor 90 may include a collar 97 located near first end 52. Collar 97 may be generally hexagonally shaped and configured to be rotated with a tool (not shown) to threadably connect inside hydraulic component 92. Hydraulic component 92 may be any type of component that receives or transmits fluid including, for example, a pump, a valve, or an actuator. Hydraulic component 92 may include a passage 98 for receiving female threaded adaptor 90. Hydraulic component 92 may further include an internal threaded portion 100 corresponding with external threaded portion 94 of female adaptor 90.

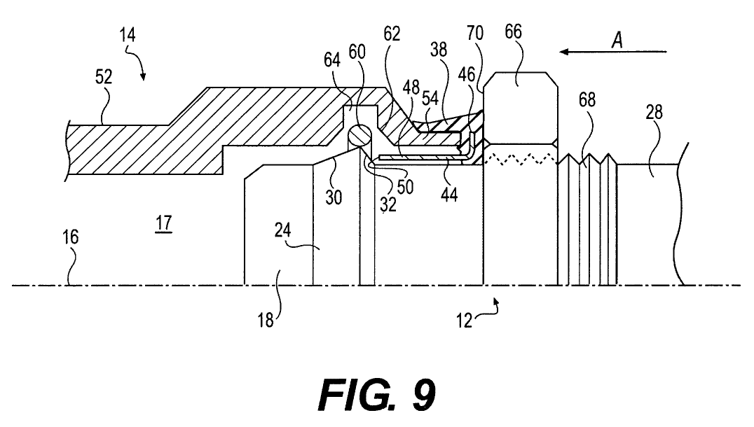

FIG. 9 shows quick connection tubular coupling 10 in a disconnected position, wherein latch ring 60 may be displaced by unlocking insert 44. FIG. 9 will be discussed in detail in the following section.

### INDUSTRIAL APPLICABILITY

The disclosed coupling may be used in any system that requires a quick connection between multiple fluid transmitting conduits. More specifically, the disclosed coupling may be used when large diameter tubular elements (i.e., greater than 1 inch in diameter) and when high maximum allowable pressures (i.e., greater than 5,000 psi) are desired. Because of its unique geometry, the disclosed coupling may be easily disconnected when high pressure is present.

Disconnection of the quick connect tubular coupling 10 from a connected position (shown in FIG. 4) may be achieved by rotating release nut 66 from a non-contact position into a contact position. In other words, an operator may manually apply torque to release nut 66 by hand or with a tool to threadably move release nut 66 in a direction indicated by arrow A. The non-contact position is shown in FIG. 4, whereby contact surface 70 of release nut 66 is separated from radial surface 40 of release sleeve 38. In this position, a gap is provided between radial surface 40 and contact surface 70. In contrast, the contact position is shown in FIG. 9, whereby contact surface 70 of release nut 66 may be in direct contact with radial surface 40 of release sleeve 38. In this position, the gap between radial surface 40, and contact surface 70 may be eliminated. Even after initial contact between contact surface 70 of release nut 66 and radial surface 40 of release sleeve 38, an operator may continue to rotate release nut 66 toward first end 18 to cause release sleeve 38 to deform due to its elastic material properties. This deformation may be generally in the direction indicated by arrow A. Since radial portion 39 of release sleeve 38 may be fixed to tubular shank 28, only an upper portion of release sleeve 38 may move in response to its deformation. Unlocking insert 44, partially embedded in release sleeve 38, may likewise move with release sleeve 38 in substantially the same direction as indicated by arrow A.

As unlocking insert 44 moves toward latch ring 60, distal end 50 of axially extending portion 48 may engage and push latch ring 60 against rearward angled surface 32 of shoulder 24, such that locking ring 60 is redirected by rearward angled surface 32 in a direction radially outward and toward second end 56 of female connector 14. In this manner, locking ring 60 may be moved from the locked position into the expanded position inside annular groove 64. Expansion of latch ring 60 into the expanded position may permit shoulder 24 to pass through latch ring 60 and disconnect from female connector 14 when an operator moves male connector 12 away from female connector 14. An operator may urge against gripping lip 72 to separate male connector 12 and female connector 14. Once quick connect tubular coupling 10 is disconnected, an operator may move release nut 66 in a direction toward second end 20 to the non-contact position such that quick connect tubular coupling 10 may be ready for connection at a future point in time.

It will be apparent to those skilled in the art that various modifications and variations can be made to the disclosed quick connect tubular coupling without departing from the scope of the disclosure. Other embodiments of the quick connect tubular coupling will be apparent to those skilled in the art from consideration of the specification and practice of the control system disclosed herein. It is intended that the specification and examples be considered as exemplary only, with a true scope of the disclosure being indicated by the following claims and their equivalents.

What is claimed is:

1. A male connector, comprising:
a tubular shank;
a release sleeve connected to the tubular shank;
an unlocking insert movable with the release sleeve; and
a release nut threadably attached to the tubular shank and configured to contact the release sleeve and move the unlocking insert.

2. The male connector of claim 1, further including a shoulder extending from the tubular shank, the shoulder including a forward angled surface and a rearward angled surface.

3. The male connector of claim 2, wherein the forward angle surface is steeper than the rearward angled surface, relative to a longitudinal axis of the tubular shank.

4. The male connector of claim 3, wherein the forward angle surface is within a range of about 5-25 degrees, and the rearward angle surface is within a range of about 30-60 degrees, relative to the longitudinal axis.

5. The male connector of claim 4, wherein the forward angle surface is within a range of about 5-8 degrees, and rearward angle surface is within a range of about 46-60 degrees, relative to the longitudinal axis.

6. The male connector of claim 1, wherein the release nut is a polygonal nut configured to be moved with a tool.

7. The male connector of claim 1, wherein the release nut includes a contact surface and the release sleeve includes an opposing radial surface.

8. The male connector of claim 7, wherein the release nut is movable to engage the contact surface with the opposing radial surface.

9. The male connector of claim 1, wherein the release sleeve is fixedly attached to the tubular shank and the unlocking insert is at least partially embedded in the release sleeve.

10. The male connector of claim 9, wherein the release nut is configured to move the release sleeve and the unlocking insert by elastically deforming the release sleeve.

11. The male connector of claim 1, further including a cylindrical stop connected to the tubular shank and being configured to limit movement of the release nut.

12. The male connector of claim 11, further including a gripping lip connected to the tubular shank having a radius, the radius is greater than a radius of the cylindrical stop.

13. The male connector of claim 1, wherein the tubular shank includes a plurality of indents configured to receive spring-loaded balls of a female connector.

14. A female connector, comprising:
a tubular member;
a bore located within the tubular member and having a central axis;
an annular groove located within the bore;
a flexible latch ring disposed within the annular groove; and
at least one spring-loaded ball positioned in the bore and biased toward the central axis.

15. The female connector of claim 14, wherein the tubular member includes an outer surface and threads extending along a majority of the outer surface.

16. The female connector of claim 14, wherein the at least one spring-loaded ball includes a plurality of spring-loaded balls.

17. The female connector of claim 16, wherein the plurality of spring loaded balls are substantially equally and annually spaced about the bore and biased toward the central axis.

18. A tubular coupling comprising:
a male connector including an elastically deformable release sleeve attached to a tubular shank, and an unlocking insert at least partially embedded in and movable with the release sleeve;
a female connector including an expandable latch ring configured to couple the male connector to the female connector; and
a threaded release nut movably attached to the male connector and configured to move from a non-contact position to a contact position against the release sleeve to thereby force the unlocking insert to push the latch ring.

19. The tubular coupling of claim 18, wherein the tubular shank includes a plurality of indents and the female connector includes an equal number of corresponding spring-loaded balls, the spring-loaded balls being configured to engage the indents and inhibit relative rotation between the male connector and the female connector when the tubular coupling is secured.

20. The tubular coupling of claim 18, wherein the male connector includes a shoulder having a forward angled surface within a range of about 5-25 degrees relative to a longitudinal axis of the tubular shank, and rearward angle surface within a range of about 30-60 degrees relative to the longitudinal axis.
